(19) United States
(12) Patent Application Publication
(10) Pub. No.: US 2018/0031848 A1
(43) Pub. Date: Feb. 1, 2018

(54) Binocular See-Through Augmented Reality (AR) Head Mounted Display Device Which is Able to Automatically Adjust Depth of Field and Depth Of Field Adjustment Method ThereforT

(71) Applicant: CHENGDU IDEALSEE TECHNOLOGY CO., LTD., Chengdu, Sichuan (CN)

(72) Inventors: Qinhua Huang, Chengdu, Sichuan (CN); Haitao Song, Chengdu, Sichuan (CN)

(73) Assignee: Chengdu Idealsee Technology Co., Ltd., Chengdu, Sichuan (CN)

(21) Appl. No.: 15/545,324

(22) PCT Filed: Aug. 7, 2015
(86) PCT No.: PCT/CN2015/086346

§ 371 Date: Jul. 21, 2017

(30) Foreign Application Priority Data
Jan. 21, 2015 (CN) 201510029819.5

(51) Int. Cl. G02B 27/01

(52) U.S. Cl. CPC G02B 27/0179; G02B 27/0172; G06T 7/593

(57) ABSTRACT

A depth of field adjustment method for a binocular see-through AR head-mounted display device includes steps of: obtaining a distance dis between a target object and human eyes (204); making a distance Lₙ between a virtual image formed by effective display information through optical systems and the human eyes (204) equivalent to the distance dis between the target object and the human eyes (204); according to the distance Lₙ between the virtual image and the human eyes (204) and a preset distance mapping relationship δ, obtaining an equivalent center distance dₙ between left and right groups of the effective display information; and according to the equivalent center distance dₙ, displaying information source images required to be displayed of virtual information respectively on left and right image display sources (201a, 201b). A binocular see-through AR head-mounted display device is further provided.

### CROSS REFERENCE OF RELATED APPLICATION

This is a U.S. National Stage under 35 U.S.371 of the International Application PCT/CN2015/086346, filed Aug. 07, 2015, which claims priority under 35 U.S.C. 119(a-d) to CN 201510029819.5, filed Jan. 21, 2015. All contents of the priority document are included into this application by reference.

### BACKGROUND OF THE PRESENT INVENTION

### Field of Invention

The present invention relates to a field of head-mounted display device, and more particularly to a binocular see-through augmented reality (AR) head-mounted display device which is able to automatically adjust a depth of field and a depth of field adjustment method therefor.

### Description of Related Arts

With the rise of the wearable device, various head-mounted display devices have become the research and development hotspot of the giant companies and gradually come into the public view. The head-mounted display device is a best operation environment of the augmented reality technique (AR for short) and is able to display the virtual information in the real environment through the head-mounted display device window.

However, for the overlay of the AR information, most of the conventional AR head-mounted display devices merely consider the correlation with the X-axis and Y-axis coordinates of the target position, without considering the depth information of the target, so that the virtual information floats in front of the human eyes and is not highly integrated with the environment, thereby causing the bad user experience of the AR head-mounted display device.

In the prior arts, many methods for adjusting the depth of field on the head-mounted display device exist. Most of the methods adjust the optical structure of the optical lens set mechanically, so as to change the image distance of the optical element and further realize the depth of field adjustment of the virtual image. However, the above methods cause the problems, such as the large volume of the head-mounted display device, the high cost and the uncontrollable precision.

### SUMMARY OF THE PRESENT INVENTION

An object of the present invention is to overcome problems of conventional augmented reality (AR) head-mounted display devices caused by adjusting a depth of field mechanically, such as a large volume, a high cost and an uncontrollable precision. In order to overcome the above problems, the present invention firstly provides a depth of field adjustment method for a binocular see-through AR head-mounted display device, comprising steps of:

obtaining a distance dis between a target object and human eyes;

making a distance Lₙ between a virtual image and the human eyes equivalent to the distance dis between the target object and the human eyes, wherein the virtual image is formed by effective display information through optical systems; and, according to the distance Lₙ between the virtual image and the human eyes and a preset distance mapping relationship δ, obtaining an equivalent center distance dₙ between left and right groups of the effective display information, wherein the preset distance mapping relationship represents a mapping relationship between the equivalent center distance dₙ and the distance Lₙ between the virtual image and the human eyes; and

according to the equivalent center distance dₙ, displaying information source images required to be displayed of virtual information respectively on left and right image display sources.

Preferably, the distance dis between the target object and the human eyes is obtained through a stereo vision system.

Further preferably, the distance dis between the target object and the human eyes is determined according to an expression of

$$dis = Z + h + \frac{f T}{{x}^{l} - {x}^{r}} + h ,$$

wherein:

h represents a distance between the stereo vision system and the human eyes; Z represents a distance between the target object and the stereo vision system; T represents a baseline distance; f represents a focal length; and, x^{l} and x^{r} respectively represent an x-coordinate of the target object in a left image and a right image.

Preferably, through a gaze tracking system, spatial gaze information data when the human eyes are gazing at the target object are detected, and according to the spatial gaze information data, the distance dis between the target object and the human eyes is determined.

Further preferably, the distance dis between the target object and the human eyes is determined according to an expression of:

$$dis = {R}_{z} + \frac{cos ( {R}_{γ} ) * cos ( {L}_{β} ) * ( {L}_{x} - {R}_{x} ) + cos ( {R}_{γ} ) * cos ( {L}_{α} ) * ( {R}_{y} - {L}_{y} )}{cos ( {L}_{β} ) * cos ( {R}_{α} ) - cos ( {L}_{α} ) * cos ( {R}_{β} )} ,$$

wherein:

(Lₓ, L_{y}, L_{z}) and (L_{α}, L_{β}, L_{γ}) respectively represent coordinates and direction angles of the target object in a left gaze vector; and, (Rₓ, R_{y}, R_{z}) and (R_{α}, R_{β}, R_{γ}) respectively represent coordinates and direction angles of the target object in a right gaze vector.

Preferably, the distance dis between the target object and the human eyes is determined through an imaging ratio of a camera.

Preferably, the distance dis between the target object and the human eyes is determined through a depth of field camera.

Preferably, in the method, through presetting a display position of the virtual information on a left side or a right side, combined with the equivalent center distance dₙ, the display position of the virtual information on the right side or the left side is determined; and, according to the display positions of the virtual information on the left and right sides, the information source images of the virtual information on the left and right sides are respectively displayed on the left image display source and the right image display source.

Preferably, according to the equivalent center distance dₙ, with a preset point as an equivalent center symmetry point, the information source images required to be displayed of the virtual information are respectively displayed on the left and right image display sources.

Preferably, the preset distance mapping relationship δ is a functional expression, a discrete data relationship, or a relationship between a projection distance range and the equivalent center distance dₙ.

Preferably, the preset distance mapping relationship δ is expressed as:

$${L}_{n} = \frac{{D}_{0} [ fL - {L}_{1} ( L - f ) ]}{( {d}_{0} - {D}_{0} ) ( L - f ) - f ( {d}_{n} - {d}_{0} )} ,$$

wherein:

D₀ represents an interpupillary distance of a user; L₁ represents an equivalent distance between the human eyes and lens sets of the optical systems; L represents a distance between the image display sources and the lens sets of the optical systems; f represents the focal length; and d₀ represents an equivalent optical axis distance between two groups of the optical systems of the head-mounted display device.

The present invention further provides a binocular see-through AR head-mounted display device which is able to automatically adjust a depth of field, comprising:

the optical systems;

the image display sources, comprising the left image display source and the right image display source;

a distance data collecting module, for obtaining related data of the distance dis between the target object and the human eyes; and

a data processing module connected with the distance data collecting module, for determining the distance dis between the target object and the human eyes according to the related data of the distance dis between the target object and the human eyes, for determining the distance Lₙ between the virtual image and the human eyes according to the distance dis between the target object and the human eyes, for obtaining the equivalent center distance dₙ between the left and right groups of the effective display information corresponding to the distance dis between the target object and the human eyes through combining with the preset distance mapping relationship δ, and for displaying the information source images required to be displayed of the virtual information respectively on the left and right image display sources according to the equivalent center distance dₙ; wherein: the preset distance mapping relationship δ represents the mapping relationship between the equivalent center distance dₙ and the distance Lₙ between the virtual image and the human eyes.

Preferably, the distance data collecting module is a single camera, the stereo vision system, the depth of field camera or the gaze tracking system.

Preferably, the data processing module determines the display position of the virtual information on the right side or the left side through presetting the display position of the virtual information on the left side or the right side combined with the equivalent center distance dₙ, and according to the display positions of the virtual information on the left and right sides, displays the information source images of the virtual information on the left and right sides respectively on the left image display source and the right image display source.

Preferably, with the preset point as the equivalent center symmetry point, according to the equivalent center distance dₙ, the data processing module displays the information source images required to be displayed of the virtual information respectively on the left and right image display sources.

Preferably, the preset distance mapping relationship δ is the functional expression, the discrete data relationship, or the relationship between the projection distance range and the equivalent center distance dₙ.

Preferably, the preset distance mapping relationship δ is expressed as:

$${L}_{n} = \frac{{D}_{0} [ fL - {L}_{1} ( L - f ) ]}{( {d}_{0} - {D}_{0} ) ( L - f ) - f ( {d}_{n} - {d}_{0} )} ,$$

wherein:

D₀ represents the interpupillary distance of the user; L₁ represents the equivalent distance between the human eyes and the lens sets of the optical systems; L represents the distance between the image display sources and the lens sets of the optical systems; f represents the focal length; and d₀ represents the equivalent optical axis distance between the two groups of the optical systems of the head-mounted display device.

According to a theory that the virtual image has a consistent spatial position as the target object when the distance Lₙ between the virtual image and the human eyes is equal to the vertical distance dis between the target object and the user, the present invention accurately overlays the virtual information to a position near the gaze point of the human eyes, so that the virtual information is highly integrated with the environment, thereby realizing a real sense of the augmented virtual reality. The present invention is simple that merely the distance dis between the target object and the human eyes is required to be obtained under the premise of presetting the distance mapping relationship δ in the head-mounted display device. The methods for testing the distance dis are various and able to be realized through the methods or devices of binocular distance measurement or depth of field camera, which have a high reliability and a low cost.

The conventional depth of field adjustment method is started with changing the image distance of the optical element. The present invention breaks the traditional thinking and realizes the depth of field adjustment through adjusting the equivalent center distance between the left and right groups of the effective display information on the image display sources without changing the structure of the optical device. Thus, the present invention is creativity and has more practicability in comparison with changing the optical focal length.

Other features and advantages of the present invention will be illustrated in the following detailed description, and part of the features and advantages will become apparent from the specification or can be understood through implementing the present invention. The objects and other advantages of the present invention can be realized and achieved through the structure specially pointed out in the specification, claims and accompanying drawings.

### BRIEF DESCRIPTION OF THE DRAWINGS

In order to more clearly illustrate the technical solutions of the embodiments of the present invention or prior arts, the accompanying drawings for describing the embodiments or the prior arts are simply described as follows. Obviously, the following accompanying drawings are only some embodiments of the present invention, and one skilled in the art can derive other drawings from the accompanying drawings without creative efforts.

FIG. 1 is a sketch view of spatial gaze paths of human eyes.

FIG. 2 is a sketch view of a first arrangement of optical modules of a head-mounted display device according to the preferred embodiment of the present invention.

FIG. 3 is a sketch view of an equivalent center distance between effective display information on image display sources of the head-mounted display device shown in FIG. 2.

FIG. 4 is a sketch view of a second arrangement of the optical modules of the head-mounted display device according to the preferred embodiment of the present invention.

FIG. 5 is a sketch view of an equivalent center distance between effective display information on image display sources of the head-mounted display device shown in FIG. 4.

FIG. 6 is a flow chart of a depth of field adjustment method for the binocular see-through augmented reality (AR) head-mounted display device according to the preferred embodiment of the present invention.

FIG. 7 and FIG. 8 are sketch views of lens imaging.

FIG. 9 is an imaging sketch view of the binocular see-through AR head-mounted display device according to the preferred embodiment of the present invention.

### DETAILED DESCRIPTION OF THE PREFERRED EMBODIMENT

Combined with the accompanying drawings, the technical solutions of the embodiments of the present invention are clearly and completely described as follows. Obviously, the described embodiments are some embodiments of the present invention, not all of the embodiments. Based on the embodiments of the present invention, other embodiments obtained by one skilled in the art without creative efforts belong to the protection scope of the present invention.

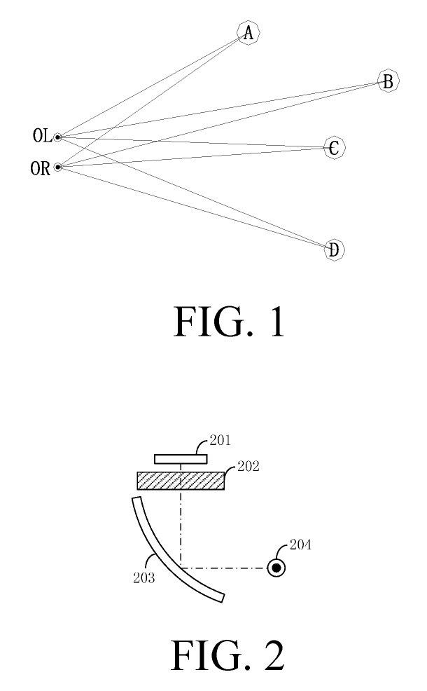

When human eyes (comprising a left eye OL and a right eye OR) gaze at target objects in different space regions, gaze vectors of the left eye OL and the right eye OR are different. FIG. 1 is a sketch view of spatial gaze paths of the human eyes. In FIG. 1, A, B, C and D represent the target objects of different directions in space. When the human eyes observe or gaze at one target object, gaze directions of the left and right eyes are respectively space vectors represented by corresponding segments.

For example, when the human eyes gaze at the target object A, the gaze directions of the left eye OL and the right eye OR are respectively space vectors represented by a segment OLA and a segment ORA; when the human eyes gaze at the target object B, the gaze directions of the left eye OL and the right eye OR are respectively space vectors represented by a segment OLB and a segment ORB. After obtaining the gaze space vectors of the left and right eyes when gazing at one target object (for example the target object A), a distance between the target object and the human eyes can be calculated according to the gaze space vectors.

When the human eyes gaze at one target object (for example the target object A), in a user coordinate system, a left gaze vector L in the left and right gaze space vectors of the human eyes can be represented as (Lₓ, L_{y}, L_{z}, L_{α}, L_{β}, L_{γ}), wherein (Lₓ, L_{y}, L_{z}) are coordinates of a point in the left gaze vector and (L_{α}, L_{β}, L_{γ}) is direction angles of the left gaze vector; and in a similar way, a right gaze vector R can be represented as (Rₓ, R_{y}, R_{z}, R_{α}, R_{β}, R_{γ}).

According to a spatial analytic method, through the left and right gaze vectors of the human eyes, a vertical distance dis between a gaze point (for example the target object A) and a user is obtained that:

$$dis = {R}_{z} + \frac{cos ( {R}_{γ} ) * cos ( {L}_{β} ) * ( {L}_{x} - {R}_{x} ) + cos ( {R}_{γ} ) * cos ( {L}_{α} ) * ( {R}_{y} - {L}_{y} )}{cos ( {L}_{β} ) * cos ( {R}_{α} ) - cos ( {L}_{α} ) * cos ( {R}_{β} )} . \qquad ( 1 )$$

In a field of augmented reality head-mounted display device, through a binocular head-mounted display device, the left and right eyes of the user are able to respectively observe left and right virtual images. When a gaze of the left eye observing the left virtual image meets a gaze of the right eye observing the right virtual image in a space region, what is observed by the two eyes of the user is an overlaid virtual image at a certain distance from the user. A distance Lₙ between the virtual image and the human eyes is determined by the left and right virtual images respectively with the gaze space vectors of the left and right eyes. When the distance Lₙ between the virtual image and the human eyes is equal to the vertical distance dis between the target object and the user, the virtual image has a consistent spatial position as the target object.

The gaze space vectors of the left and right eyes are determined by the observed target object, and on the binocular head-mounted display device, an equivalent center distance between left and right groups of effective display information also determines the gaze space vectors of the left and right eyes, so that a relationship exists between the projection distance Lₙ of the virtual image in the binocular head-mounted display device and the equivalent center distance between the left and right groups of the effective display information on image display sources of the head-mounted display device, and the relationship is namely a distance mapping relationship δ. That is to say, the distance mapping relationship δ represents the mapping relationship between the equivalent center distance dₙ between the left and right groups of the effective display information on the image display sources of the head-mounted display device and the projection distance Lₙ of the virtual image formed by the effective display information through optical systems.

It should be pointed out that: in different embodiments of the present invention, the distance mapping relationship δ can be a formula, a discrete data relationship, or a relationship between a projection distance range and the equivalent center distance, and the present invention is not limited thereto.

It should be further pointed out that: in the different embodiments of the present invention, the distance mapping relationship δ can be obtained through various methods (for example, determining the distance mapping relationship δ through experimental data fitting and then storing the obtained distance mapping relationship δ in the head-mounted display device before leaving factory), and the present invention is not limited thereto.

According to the preferred embodiment of the present invention, when a visual optical system with the human eyes as exit pupils adopts a converse light route design system, an axis, which passes through an exit pupil center and is perpendicular to an exit pupil plane, serves as an equivalent optical axis.

In the visual optical system with the human eyes as the exit pupils, a light ray passing through the optical axis (namely the light ray passes through the exit pupil center and is perpendicular to the exit pupil plane) can be conversely tracked. When the light ray intersects with one optical plane for a first time, the optical plane serves as a first optical plane and a first plane tangent to the first optical plane is made at an intersection of the light ray and the first optical plane, and non-tracked optical planes after the first optical plane are expanded with the first plane as a mirror plane (namely the first plane serves as the mirror plane, so as to obtain symmetric images of the non-tracked optical planes after the first optical plane). In the expanded optical system, the light ray is continuously tracked in a system of the non-tracked optical planes. When the light ray intersects with one optical plane for a second time, the optical plane serves as a second optical plane and a second plane tangent to the second optical plane is made at an intersection point of the light ray and the second optical plane, and non-tracked optical planes after the second optical plane are expanded with the second optical plane as the mirror plane. The above process is continued until the last optical plane is expanded, so that an expanded symmetric image of an image source display screen is obtained and serves as an equivalent image source display screen.

According to the preferred embodiment of the present invention, the equivalent center distance dₙ represents a center distance between the left and right groups of the effective display information on the equivalent image source display screens. For one skilled in the art, it can be understood that a connecting line of center points of the left and right groups of the effective display information on the equivalent image source display screens must be perpendicular to an OS axis, so as to overlay the information displayed on the left and right equivalent image source display screens. Therefore, unless particularly illustrated, the equivalent center distance dₙ is the distance under a condition that the connecting line of the center points of the left and right groups of the effective display information is perpendicular to the OS axis.

FIG. 2 is a sketch view of a first arrangement of optical modules of the head-mounted display device according to the preferred embodiment of the present invention. The image display source 201 is located above the human eye 204, and after a light ray emitted by the image display source 201 is amplified through an amplification system 202, the light ray is reflected into the human eye 204 by a transflective mirror 203.

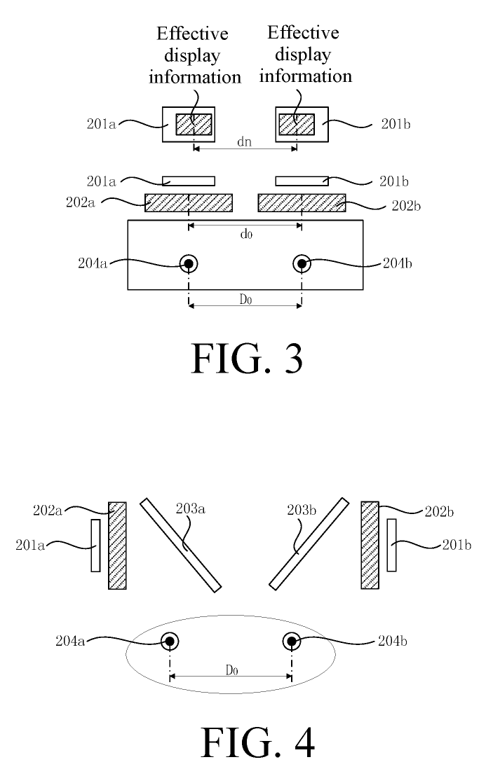

FIG. 3 is a sketch view of the equivalent center distance between the effective display information on the image display sources of the head-mounted display device shown in FIG. 2. The effective display information on a left image display source 201a and a right image display source 201b respectively passes through a left amplification system 202a and a right amplification system 202b, and thereafter is reflected into the left eye 204a and the right eye 204b by the corresponding transflective mirrors, wherein the equivalent center distance between the effective display information on the image display sources is denoted as dₙ, an equivalent center distance between the amplification systems is denoted as d₀, and an interpupillary distance is denoted as D₀ .

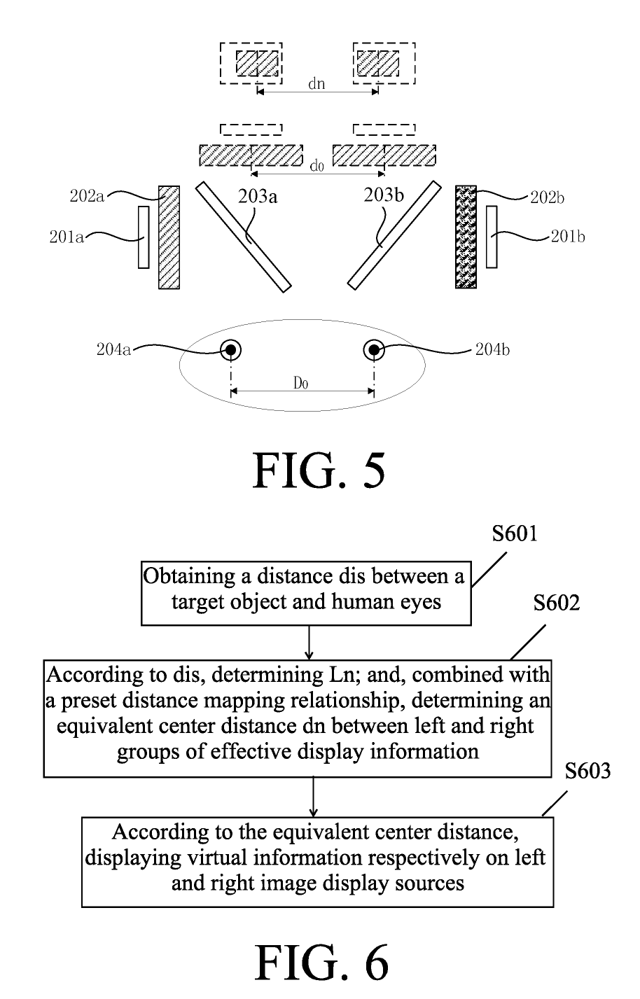

According to the preferred embodiment of the present invention, if the optical modules of the head-mounted display device adopt an arrangement as shown in FIG. 4 (namely the left image display source 201a and the right image display source 201b are respectively located at a left side of the left eye 204a and a right side of the right eye 204b), the effective display information on the left image display source 201a and the right image display source 201b respectively passes through the left amplification system 202a and the right amplification system 202b, and thereafter is reflected into the left eye 204a and the right eye 204b respectively by a left transflective mirror 203a and a right transflective mirror 203b, and meanwhile the equivalent center distance d₀between the effective display information on the image display sources, the equivalent center distance d₀between the amplification systems and the interpupillary distance D₀ are shown in FIG. 5.

FIG. 6 is a flow chart of a depth of field adjustment method for the binocular see-through AR head-mounted display device provided by the preferred embodiment.

According to the preferred embodiment, the depth of field adjustment method for the binocular see-through AR head-mounted display device comprises a step of: S601, when the user gazes at one target object in an external environment through the head-mounted display device, obtaining the distance dis between the target object and the human eyes.

According to the preferred embodiment, in the step of S601, the head-mounted display device obtains the distance dis between the target object and the human eyes through a stereo vision system which mainly utilizes a parallax principle to measure the distance. Particularly, the stereo vision system determines the distance dis between the target object and the human eyes according to an expression of:

$$dis = Z + h = \frac{fT}{{x}^{l} - {x}^{r}} + h , \qquad ( 2 )$$

wherein: h represents a distance between the stereo vision system and the human eyes; Z represents a distance between the target object and the stereo vision system; T represents a baseline distance; f represents a focal length of the stereo vision system; and, x^{l} and x^{r} respectively represent an x-coordinate of the target object in a left image and a right image.

It is noted that: in the different embodiments of the present invention, the stereo vision system can be realized through adopting various specific devices, and the present invention is not limited thereto. For example, in the different embodiments of the present invention, the stereo vision system can be two cameras having the same focal length, a camera in motion, or other rational devices.

It is further noted that: in other embodiments of the present invention, the head-mounted display device is able to obtain the distance dis between the target object and the human eyes through adopting other rational methods, and the present invention is also not limited thereto. For example, in the different embodiments of the present invention, the head-mounted display device can obtain the distance dis between the target object and the human eyes through a depth of field camera, through detecting spatial gaze information data when the human eyes are gazing at the target object by a gaze tracking system and then determining the distance dis between the target object and the human eyes according to the spatial gaze information data, or through a camera imaging ratio to determine the distance dis between the target object and the human eyes.

When the head-mounted display device obtains the distance dis between the target object and the human eyes through the depth of field camera, the head-mounted display device obtains a depth of field ΔL, through calculating according to expressions of:

$$\begin{matrix}Δ {L}_{1} = \frac{{Fd}_{bs} {L}^{2}}{{f}^{2} + {Fd}_{bs} L} & ( 3 ) \\ Δ {L}_{2} = \frac{{Fd}_{bs} {L}^{2}}{{f}^{2} - {Fd}_{bs} L} & ( 4 ) \\ Δ L = Δ {L}_{1} + Δ {L}_{2} = \frac{2 {f}^{2} {Fd}_{bs } {L}^{2}}{{f}^{4} - {F}^{2} {d}_{bs}^{2} {L}^{2}} , & ( 5 )\end{matrix}$$

wherein: ΔL₁ and ΔL₂ respectively represent a front depth of field and a back depth of field; d_{bs} represents an allowable diameter of a blur spot; f represents a focal length of a camera lens; and L represents a focusing distance. At the moment, the depth of field ΔL is namely the distance dis between the target object and the human eyes.

When the head-mounted display device calculates the distance dis between the target object and the human eyes through detecting the spatial gaze information data when the human eyes are gazing at the target object by the gaze tracking system, the head-mounted display device adopts the technical solutions illustrated in FIG. 1 and expression (1) to determine the distance dis between the target object and the human eyes, and no more detailed description is provided herein.

When the head-mounted display device calculates the distance dis between the target object and the human eyes through the camera imaging ratio, an actual size of the target object is required to be pre-stored in a database, then the camera takes a picture including the target object and a pixel size of the target object in the picture is calculated, next the pre-stored actual size of the target object in the database is obtained with the picture, and finally the distance dis between the target object and the human eyes is calculated through the pixel size of the target object in the picture and the actual size of the target object.

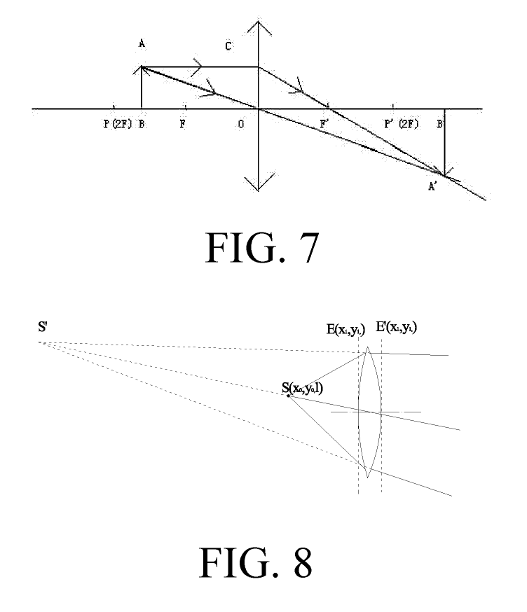

FIG. 7 is a sketch view of camera imaging, wherein: AB represents an object; A′B′ represents an image; an object distance OB is denoted as u; an image distance OB′ is denoted as v, and through a triangle similarity relationship, a following expression is obtained that:

$$\frac{x}{u} = \frac{y}{v} . \qquad ( 6 )$$

From the expression (6), a following expression is obtained that:

$$u = \frac{y}{x} \cdot v , \qquad ( 7 )$$

wherein: x represents an object length and y represents an image length.

When the focal length of the camera is fixed, the object distance can be calculated through the expression (7). According to the preferred embodiment, the distance between the target object and the human eyes is namely the object distance u, the actual size of the target object is namely the object length x, and the pixel size of the target object is namely the image length y. The image distance v is determined according to an internal optical structure of the camera; and, after the optical structure of the camera is determined, the image distance v is a constant value.

As shown in FIG. 6, after obtaining the distance dis between the target object and the human eyes, in a step of S602, according to the distance dis between the target object and the human eyes, the distance Lₙ between the virtual image formed by the effective display information through the optical systems and the human eyes is determined, and then the equivalent center distance dₙ between the left and right groups of the effective display information is determined through the preset distance mapping relationship δ. According to the preferred embodiment, the preset distance mapping relationship δ is preset in the head-mounted display device, which can be the formula, the discrete data relationship, or the relationship between the projection distance range and the equivalent center distance.

Particularly, according to the preferred embodiment, the distance mapping relationship δ is expressed through a following expression of:

$${L}_{n} = \frac{{D}_{0} [ fL - {L}_{1} ( L - f ) ]}{( {d}_{0} - {D}_{0} ) ( L - f ) - f ( {d}_{n} - {d}_{0} )} , \qquad ( 8 )$$

wherein: Lₙ represents the distance between the virtual image formed by the effective display information through the optical systems and the human eyes; D₀ represents the interpupillary distance of the user; L₁ represents an equivalent distance between the human eyes and lens sets of the optical systems; L represents a distance between the image display sources and the lens sets of the optical systems; f represents the focal length of the lens sets of the optical systems; and, d₀represents an equivalent optical axis distance between two groups of the optical systems in the head-mounted display device. After the structure of the head-mounted display device is fixed, the parameters of D₀ , L₁, L, f and d₀are normally fixed values; and, at the moment, the distance Lₙ between the virtual image and the human eyes is merely related to the equivalent center distance dₙ between the left and right groups of the effective display information.

Particularly, when the distance Lₙ between the virtual image and the human eyes is equal to the dis between the target object and the human eyes, the virtual image and the target object have the consistent spatial position. Therefore, according to the preferred embodiment, in the step of S602, the distance Lₙ between the virtual image formed by the effective display information through the optical systems and the human eyes is made equivalent to the distance dis between the target object and the human eyes, so that the virtual information has the consistent spatial position as the target object.

It is noted that: in other embodiments of the present invention, the distance mapping relationship δ can be expressed in other rational forms, and the present invention is not limited thereto.

After obtaining the equivalent center distance dₙ, in a step of S603, with the equivalent center distance dₙ as the center distance, information source images required to be displayed of the virtual information are respectively displayed on the left and right image display sources.

Particularly, according to the preferred embodiment, a display position of the virtual information on the left image display source is preset. Thus, in the step of S603, with the display position of the virtual information on a left side as a base, a display position of the virtual information on a right side is determined according to the equivalent center distance dₙ.

For example, preset coordinates of a center point of the virtual information on the left side are (xₗ, yₗ), and thus coordinates of a center point of the virtual information on the right side can be calculated through an expression of:

(xᵣ, yᵣ)=(xₗ+dₙ, yₗ) (9).

Similarly, in other embodiments of the present invention, the display position of the virtual information on the right side can be preset, then the display position of the virtual information on the right side serves as the base in the step of S603, and the display position of the virtual information on the left side is determined according to the equivalent center distance dₙ.

It is noted that: in other embodiments of the present invention, in the step of S603, the display position of the virtual information can be determined through other rational methods, and the present invention is not limited thereto. For example, with a specified point as an equivalent center symmetry point, the display positions of the virtual information on the left and right sides are respectively determined according to the equivalent center distance dₙ. For example, if an intersection of an equivalent symmetry axis, namely the OS axis, of the left and right image display sources and the connecting line between the center points of the left and right image display sources serves as the equivalent center symmetry point, the virtual image will be displayed in front of the human eyes; if another point, which has certain displacement relative to the intersection, serves as the equivalent center symmetry point, the virtual image will also have certain displacement relative to the front of the human eyes.

The preferred embodiment further provides a binocular see-through AR head-mounted display device which is able to automatically adjust the depth of field, comprising optical systems, image display sources, a distance data collecting module and a data processing module, wherein: each optical system comprises at least one lens, and the user can see a real external environment and the virtual information displayed on the image display sources at the same time through the optical systems; the distance mapping relationship δ is stored in the data processing module and is able to represent the mapping relationship between the equivalent center distance dₙ between the left and right groups of the effective display information on the image display sources of the head-mounted display device and the distance Lₙ, between the virtual image formed by the effective display information through the optical systems and the human eyes.

The equivalent center distance d in the distance mapping relationship δ has a value range of [0, d₀], wherein d₀represents the equivalent optical axis distance between the two groups of the optical systems in the head-mounted display device. According to the preferred embodiment, the distance mapping relationship δ is expressed as the expression (8).

When the user sees the external environment through the optical systems of the head-mounted display device, the distance data collecting module obtains related data of the distance dis between the target object and the human eyes, and then sends the data to the data processing module.

The distance data collecting module can be a single camera, the stereo vision system, the depth of field camera or the gaze tracking system. When the distance data collecting module is the single camera, the distance data collecting module obtains the related data of the distance dis between the target object and the human eyes through the camera imaging ratio. When the distance data collecting module is the stereo vision system, the distance data collecting module obtains the related data of the distance dis between the target object and the human eyes through distance measurement based on the parallax principle. When the distance data collecting module is the gaze tracking system, the distance data collecting module obtains the related data of the distance dis between the target object and the human eyes through the expression (1). When the distance data collecting module is the depth of field camera, the distance data collecting module is able to directly obtain the related data of the distance dis between the target object and the human eyes.

According to the data sent from the distance data collecting module, the data processing module calculates the distance dis between the target object and the human eyes, then makes the distance Lₙ between the virtual image formed by the effective display information through the optical systems and the human eyes equivalent to the dis between the target object and the human eyes, and combined with the distance mapping relationship δ, obtains the equivalent center distance d between the left and right groups of the effective display information corresponding to the distance Lₙ between the virtual image and the human eyes.

According to the equivalent center distance dₙ, the data processing module controls the image display sources that: with the specified point as the equivalent center symmetry point, the data processing module displays the information source images required to be displayed of the virtual information respectively on the left and right image display sources, wherein: if the intersection of the OS axis and the connecting line between the center points of the left and right image display sources serves as the equivalent center symmetry point, the virtual image will be displayed in front of the human eyes; if another point, which has the certain displacement relative to the intersection, serves as the equivalent center symmetry point, the virtual image will also have certain displacement relative to the front of the human eyes.

According to the preferred embodiment, the distance mapping relationship δ can be the formula, the discrete data relationship or the relationship between the projection distance range and the equivalent center distance, and the present invention is not limited thereto. In the different embodiments of the present invention, the distance mapping relationship δ can be obtained through various rational methods. In order to illustrate the present invention more clearly, an obtaining method of the distance mapping relationship δ, as an example, is described as follows.

Each optical system comprises a plurality of lens. According to a physical optical theory, an imaging ability of the lens is a result of a modulating action of the lens to a phase of an incident optical wave. Referring to FIG. 8, a point object S(x₀, y₀, l) is assumed to be located at a limited distance from the lens, the lens modulates a divergent spherical wave emitted by the point object S(x₀, y₀, l), and under the paraxial approximation, a field distribution of the divergent spherical wave emitted by the point object S(x₀, y₀, l) on a front plane of the lens is expressed as:

$$\tilde{E} ( {x}_{1} , {y}_{1} ) = A exp \{ \frac{ik}{2 l} [ {( {x}_{1} - {x}_{0} )}^{2} + {( {y}_{1} - {y}_{0} )}^{2} ] \} , \qquad ( 10 )$$

a field distribution of the spherical wave after passing through the lens is expressed as:

$${\tilde{E}}^{′} ( {x}_{1} , {y}_{1} ) = \tilde{E} ( {x}_{1} {y}_{1} ) exp ( - ik \frac{{x}_{1}^{2} + {y}_{1}^{2}}{2 f} ) , \qquad ( 11 )$$

through setting

$$\frac{1}{{l}^{′}} = \frac{1}{f} - \frac{1}{l} ,$$

the above expressions are modified as:

$${\tilde{E}}^{′} ( {x}_{1} , {y}_{1} ) = A exp [ \frac{ik}{2 l} ( {x}_{0}^{2} + {y}_{0}^{2} ) ] exp [ ik ( \frac{{x}_{1}^{2} + {y}_{l}^{2}}{2 ( - {l}^{′} )} - \frac{{x}_{1} ( - {x}_{0} \frac{{l}^{′}}{l} ) + {y}_{1} ( - {y}_{0} \frac{{l}^{′}}{l} )}{- {l}^{′}} ] , \qquad ( 12 )$$

wherein: \tilde{E}(x₁, y₁) represents an optical field distribution on the front plane of the lens; \tilde{E}′(x₁, y₁) represents an optical field distribution of the optical wave after passing through the lens; A represents an amplitude of the spherical wave; k represents a wave number; l represents a distance between the point object S and an observation plane; f represents the focal length of the lens; (x₀, y₀) represent spatial plane coordinates of the point object S; and (x₁, y₁) represent coordinates of a point on a spatial plane at a distance of l from the point object S .

The expression (12) represents a spherical wave emitted to a virtual image point of

$$( - {x}_{0} \frac{{l}^{′}}{l} , - {y}_{0} \frac{{l}^{′}}{l} )$$

on a plane at a distance of (−1′) from the lens.

Referring to FIG. 1, when the human eyes (comprising the left eye OL and the right eye OR) gaze at the target objects in the different space regions, the gaze vectors of the left eye and the right eye are different. In FIG. 1, A, B, C and D represent the target objects of the different directions in space. When the human eyes observe or gaze at one target object, the gaze directions of the left and right eyes are respectively the space vectors represented by the corresponding segments.

For example, when the human eyes gaze at the target object A, the gaze directions of the left eye OL and the right eye OR are respectively the space vectors represented by the segment OLA and the segment ORA; when the human eyes gaze at the target object B, the gaze directions of the left eye OL and the right eye OR are respectively the space vectors represented by the segment OLB and the segment ORB. After obtaining the gaze space vectors of the left and right eyes when gazing at one target object (for example the target object A), the distance between the target object and the human eyes is able to be calculated according to the gaze space vectors.

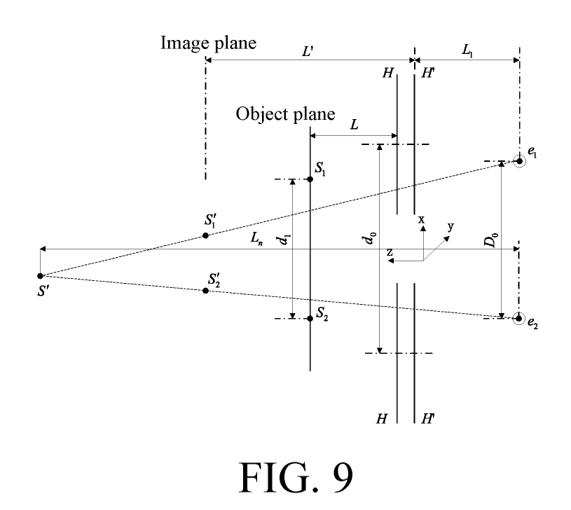

Referring to FIG. 9, a focal length of an ideal lens set is assumed to be f, (S₁, S₂) are a pair of object points on an object plane; a distance between the object point S₁ and the object point S₂ is d₁; a distance between the point objects (S₁, S₂) and a principle object plane of the lens set, namely the object distance, is L; an equivalent optical axis distance between two groups of the ideal lens sets is d₀; the interpupillary distance of the user is D₀; (S′₁, S′₂) represent corresponding virtual image points on a virtual image plane after the point objects (S₁, S₂) pass through the ideal lens set.

According to the physical optical theory, a divergent spherical wave emitted by the object point S₁, after modulating by the lens set, is a divergent spherical wave emitted by a virtual image point S′₁ on an image plane at a distance of L′ from a principle image plane H′ of the lens set; and, a divergent spherical wave emitted by the object point S₂, after modulating by the lens set, is a divergent spherical wave emitted by a virtual image point S′₂ on the image plane at the distance of L′ from the principle image plane H′ of the lens set.

When the human eyes observe the object points S₁ and S₂ through the lens set, what the human eyes respectively observe are equivalently the virtual image points S′₁ and S′₂ on a plane at a distance of (L′+L₁) from the human eyes. According to the above human eye vision theory, the virtual image point S′ will be observed by the human eyes. The virtual image point S′ is an intersection of a spatial vector, determined by a first pupil center distance e₁ and the virtual image point S′₁, and a spatial vector, determined by a second pupil center distance e₂ and the virtual image point S′₂, wherein a distance between the virtual point S′ and the human eyes is Lₙ.

Based on the optical theory and the space geometry theory, a relationship among the distance Lₙ, between the virtual image point S′ and the human eyes, the interpupillary distance D₀ of the user, the equivalent optical axis distance d₀ between the left and right groups of the lens sets, the distance between the object points on the object plane, the focal length f of the lens sets, the distance L between the object plane and the lens set (namely the object distance) and the equivalent distance L₁ between the human eyes and the lens sets of the optical systems is derived, namely:

$${L}_{n} = \frac{{D}_{0} [ fL - {L}_{1} ( L - f ) ]}{( {d}_{0} - {D}_{0} ) ( L - f ) - f ( {d}_{n} - {d}_{0} )} . \qquad ( 13 )$$

According to the above relational expression, once one or a plurality of physical quantities change, the distance between the virtual image point S′ and the human eyes is changed. In the binocular head-mounted display device, the image source display screen is namely the object plane. After the structure of the head-mounted display device is fixed, the interpupillary distance D₀ of the user, the equivalent distance L₁ between the human eyes and the lens sets of the optical systems, the distance L between the image display sources and the lens sets of the optical systems, the equivalent optical axis distance d₀between the two groups of the optical systems, and the focal length f of the lens sets of the optical systems are normally fixed values. At the moment, the distance Lₙ between the virtual image and the human eyes is merely related to the equivalent center distance dₙ between the left and right groups of the effective display information.

It is noted that: besides the above theory expression, in other embodiments of the present invention, other rational methods can be adopted to determine the distance mapping relationship δ, and the present invention is not limited thereto. For example, in other embodiments of the present invention, the distance mapping relationship δ can be obtained through summarizing the experimental data. Particularly, when many testers gaze at the target objects of different distances, through adjusting the equivalent center distance dₙ between the left and right groups of the effective display information, the virtual image is overlaid to a depth of the target object, the equivalent center distance dₙ at the moment is recorded, and the distance mapping relationship δ is formed through obtaining a formula or a discrete data relationship by fitting multiple groups of the experimental data.

According to the theory that the virtual image has the consistent spatial position as the target object when the distance Lₙ between the virtual image and the human eyes is equal to the vertical distance dis between the target object and the user, the present invention accurately overlays the virtual information to a position near the gaze point of the human eyes, so that the virtual information is highly integrated with the environment, thereby realizing a real sense of augmented virtual reality. The present invention is simple that merely the distance dis between the target object and the human eyes is required to be obtained under the premise of presetting the distance mapping relationship δ in the head-mounted display device. The methods for testing the distance dis are various and able to be realized through the methods or devices of binocular distance measurement or depth of field camera, which have a high reliability and a low cost.

The conventional depth of field adjustment method is started with changing the image distance of the optical element. The present invention breaks the traditional thinking and realizes the depth of field adjustment through adjusting the equivalent center distance between the left and right groups of the effective display information on the image display sources without changing the structure of the optical device. Thus, the present invention is creativity and has more practicability in comparison with changing the optical focal length.

All of the features disclosed in the specification, or all of the methods or processes disclosed therein, can be combined in any manner other than mutually exclusive features and/or steps.

Any feature disclosed in the specification (including all of the additional claims, the abstract and the accompanying drawings), unless specifically illustrated, can be replaced by other features having the equivalent or similar purposes. That is to say, unless specifically illustrated, each feature is only an example of a series of equivalents or similar features.

The present invention is not limited to the preferred embodiment described above. The present invention can extend to any new feature or any new combination disclosed in the specification, as well as any disclosed new method, process or combination.

1. A depth of field adjustment method for a binocular see-through augmented reality (AR) head-mounted display device, comprising steps of:
obtaining a distance dis between a target object and human eyes;
making a distance Lₙ between a virtual image and the human eyes equivalent to the distance dis between the target object and the human eyes, wherein the virtual image is formed by effective display information through optical systems; and, according to the distance Lₙ between the virtual image and the human eyes and a preset distance mapping relationship δ, obtaining an equivalent center distance dₙ between left and right groups of the effective display information, wherein the preset distance mapping relationship δ represents a mapping relationship between the equivalent center distance dₙ and the distance Lₙ between the virtual image and the human eyes; and
according to the equivalent center distance dₙ, displaying information source images required to be displayed of virtual information respectively on left and right image display sources.

2. The depth of field adjustment method for the binocular see-through AR head-mounted display device, as recited in claim 1, wherein the distance dis between the target object and the human eyes is obtained through a stereo vision system.

3. The depth of field adjustment method for the binocular see-through AR head-mounted display device, as recited in claim 2, wherein the distance dis between the target object and the human eyes is determined according to an expression of:
$$dis = Z + h = \frac{fT}{{x}^{l} - {x}^{r}} + h ,$$
wherein: h represents a distance between the stereo vision system and the human eyes; Z represents a distance between the target object and the stereo vision system; T represents a baseline distance; f represents a focal length; x^{l} and x^{r} respectively represent an x-coordinate of the target object in a left image and a right image.

4. The depth of field adjustment method for the binocular see-through AR head-mounted display device, as recited in claim 1, wherein: through a gaze tracking system, spatial gaze information data when the human eyes are gazing at the target object are detected, and according to the spatial gaze information data, the distance dis between the target object and the human eyes is determined.

5. The depth of field adjustment method for the binocular see-through AR head-mounted display device, as recited in claim 4, wherein: the distance dis between the target object and the human eyes is determined according to an expression of:
$$dis = {R}_{z} + \frac{cos ( {R}_{γ} ) * cos ( {L}_{β} ) * ( {L}_{x} - {R}_{x} ) + cos ( {R}_{γ} ) * cos ( {L}_{α} ) * ( {R}_{y} - {L}_{y} )}{cos ( {L}_{β} ) * cos ( {R}_{α} ) - cos ( {L}_{α} ) * cos ( {R}_{β} )}$$
wherein:
(Lₓ, L_{y}, L_{z}) and (L_{α}, L_{β}, L_{γ}) respectively represent coordinates and direction angles of the target object in a left gaze vector; and, (Rₓ, R_{y}, R_{z}) and (R_{α}, R_{β}, R_{γ}) respectively represent coordinates and direction angles of the target object in a right gaze vector.

6. The depth of field adjustment method for the binocular see-through AR head-mounted display device, as recited in claim 1, wherein the distance dis between the target object and the human eyes is determined through a camera imaging ratio.

7. The depth of field adjustment method for the binocular see-through AR head-mounted display device, as recited in claim 1, wherein the distance dis between the target object and the human eyes is determined through a field of depth camera.

8. The depth of field adjustment method for the binocular see-through AR head-mounted display device, as recited in claim 1, wherein: through presetting a display position of the virtual information on a left side or a right side, combined with the equivalent center distance dₙ, the display position of the virtual information on the right side or the left side is determined; and, according to the display positions of the virtual information on the left and right sides, the information source images of the virtual information on the left and right sides are respectively displayed on the left image display source and the right image display source.

9. The depth of field adjustment method for the binocular see-through AR head-mounted display device, as recited in claim 1, wherein: according to the equivalent center distance dₙ, with a preset point as an equivalent center symmetry point, the information source images required to be displayed of the virtual information are respectively displayed on the left and right image display sources.

10. The depth of field adjustment method for the binocular see-through AR head-mounted display device, as recited in claim 1, wherein: the preset distance mapping relationship δ is a functional expression, a discrete data relationship or a relationship between a projection distance range and the equivalent center distance dₙ.

11. The depth of field adjustment method for the binocular see-through AR head-mounted display device, as recited in claim 10, wherein: the preset distance mapping relationship δ is the functional expression, expressed as:
$${L}_{n} = \frac{{D}_{0} [ fL - {L}_{1} ( L - f ) ]}{( {d}_{0} - {D}_{0} ) ( L - f ) - f ( {d}_{n} - {d}_{0} )} ,$$
wherein:
D₀ represents an interpupillary distance of a user; L₁ represents an equivalent distance between the human eyes and lens sets of the optical systems; L represents a distance between the image display sources and the lens sets of the optical systems; f represents a focal length; and d₀represents an equivalent optical axis distance between two groups of the optical systems of the head-mounted display device.

12. A binocular see-through AR head-mounted display device which is able to automatically adjust a depth of field, comprising:
optical systems;
image display sources, comprising a left image display source and a right image display source;
a distance data collecting module, for obtaining related data of a distance dis between a target object and human eyes; and
a data processing module, which is connected with the distance data collecting module, for determining the distance dis between the target object and the human eyes according to the related data of the distance dis between the target object and the human eyes, for determining a distance Lₙ between a virtual image and the human eyes according to the distance dis between the target object and the human eyes, for obtaining an equivalent center distance dₙ between left and right groups of effective display information corresponding to the distance dis between the target object and the human eyes through combining with a preset distance mapping relationship δ, and for displaying information source images required to be displayed of virtual information respectively on the left and right image display sources according to the equivalent center distance dₙ; wherein: the preset distance mapping relationship δ represents a mapping relationship between the equivalent center distance dₙ and the distance Lₙ between the virtual image and the human eyes.

13. The binocular see-through AR head-mounted display device which is able to automatically adjust the depth of field, as recited in claim 12, wherein the distance data collecting module is a single camera, a stereo vision system, a depth of field camera or a gaze tracking system.

14. The binocular see-through AR head-mounted display device which is able to automatically adjust the depth of field, as recited in claim 12, wherein: the data processing module determines a display position of the virtual information on a right side or a left side through presetting the display position of the virtual information on the left side or the right side combined with the equivalent center distance dₙ, and according to the display positions of the virtual information on the left and right sides, displays the information source images of the virtual information on the left and right sides respectively on the left image display source and the right image display source.

15. The binocular see-through AR head-mounted display device which is able to automatically adjust the depth of field, as recited in claim 12, wherein: with a preset point as an equivalent center symmetry point, according to the equivalent center distance dₙ, the data processing module displays the information source images required to be displayed of the virtual information respectively on the left and right image display sources.

16. The binocular see-through AR head-mounted display device which is able to automatically adjust the depth of field, as recited in claim 12, wherein: the preset distance mapping relationship δ is a functional expression, a discrete data relationship or a relationship between a projection distance range and the equivalent center distance dₙ.

17. The binocular see-through AR head-mounted display device which is able to automatically adjust the depth of field, as recited in claim 16, wherein the preset distance mapping relationship δ is the functional expression, expressed as:
$${L}_{n} = \frac{{D}_{0} [ fL - {L}_{1} ( L - f ) ]}{( {d}_{0} - {D}_{0} ) ( L - f ) - f ( {d}_{n} - {d}_{0} )} ,$$
wherein:
D₀ represents an interpupillary distance of a user; L₁ represents an equivalent distance between the human eyes and lens sets of the optical systems; L represents a distance between the image display sources and the lens sets of the optical systems; f represents a focal length; and d₀represents an equivalent optical axis distance between two groups of the optical systems of the head-mounted display device.
